(19) United States
(12) Patent Application Publication
(10) Pub. No.: US 2012/0287480 A1
(43) Pub. Date: Nov. 15, 2012

(54) SCANNER

(75) Inventors: SHI-MING OU, Tu-Cheng (TW); PO-CHUN CHEN, Tu-Cheng (TW)

(73) Assignee: HON HAI PRECISION INDUSTRY CO., LTD., Tu-Cheng (TW)

(21) Appl. No.: 13/278,457

(22) Filed: Oct. 21, 2011

(30) Foreign Application Priority Data
May 9, 2011 (TW) 100116229

(51) Int. Cl. H04N 1/04

(52) U.S. Cl. 358/474

(57) ABSTRACT

A scanner includes a base and a scanning module. The base includes a bottom panel and a sliding portion extending from the bottom panel. A sliding slot is defined in the sliding portion. The sliding slot defines a longer side surface and a first shorter side surface extending from the longer side surface. A plurality of first teeth slots is defined in the longer side surface and a plurality of second teeth slots defined in the shorter side surface. The scanning module includes a loading panel and a driving module. The driving module includes a worm gear assembly engaging the first teeth slots and is capable of moving along the longer side surface. The worm gear assembly engage the plurality of second teeth slots to prevent the scanning module from moving when the scanning module moves to the first shorter side surface along the longer side surface.

This application is related to co-pending U.S. patent application entitled “SCANNER”, Attorney Docket No. US38876, U.S. application Ser. No. ______ filed on ______.

### BACKGROUND

1. Technical Field

The disclosure generally relates to scanners, especially, to a scanner with a base for engaging a scanning module of the scanner.

2. Description of Related Art

A scanning module of a scanner is driven by a motor of the scanner to move relative to a base back and forth. When the scanning module moves to a side of the base, the scanning module needs to be repositioned and the motor must be stopped. However, the motor may not be stopped when the scanning module moves to a side of the base, which makes the scanning module work unstably.

Thus, there is room for improvement within the art.

### BRIEF DESCRIPTION OF THE DRAWINGS

FIG. 1 is an exploded, isometric view of an embodiment of a scanner.

FIG. 2 is an isometric view of a scanning module of the scanner of FIG. 1.

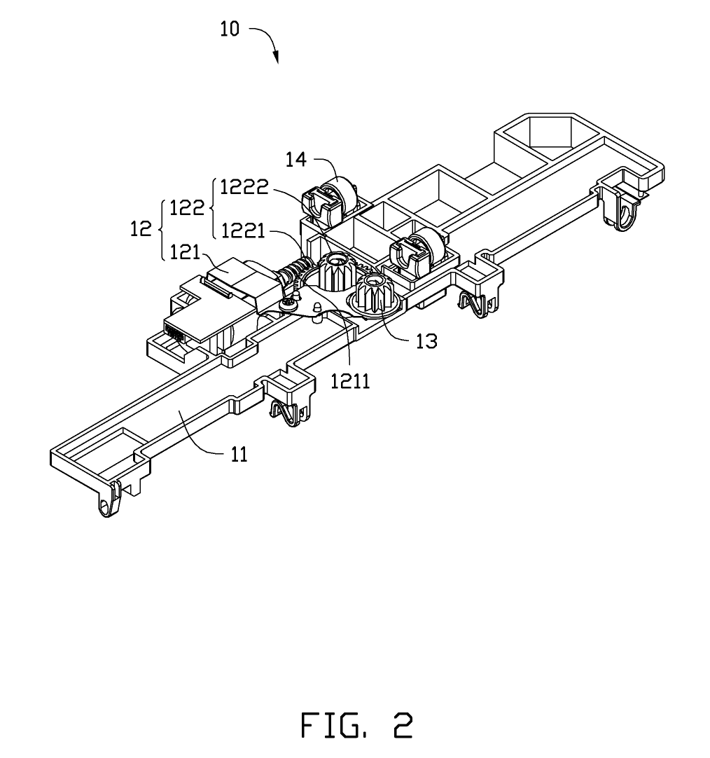

FIG. 3 is an assembled view of FIG. 1.

FIG. 4 is a planform view of FIG. 2.

FIG. 5 is an enlarged partial view of FIG. 4

FIG. 6 is an enlarged partial view of FIG. 1 when the scanning module has moved to a first end of a sliding slot of FIG. 1.

FIG. 7 is an enlarged partial view of FIG. 1 when the scanning module has moved to a second end of the sliding slot of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

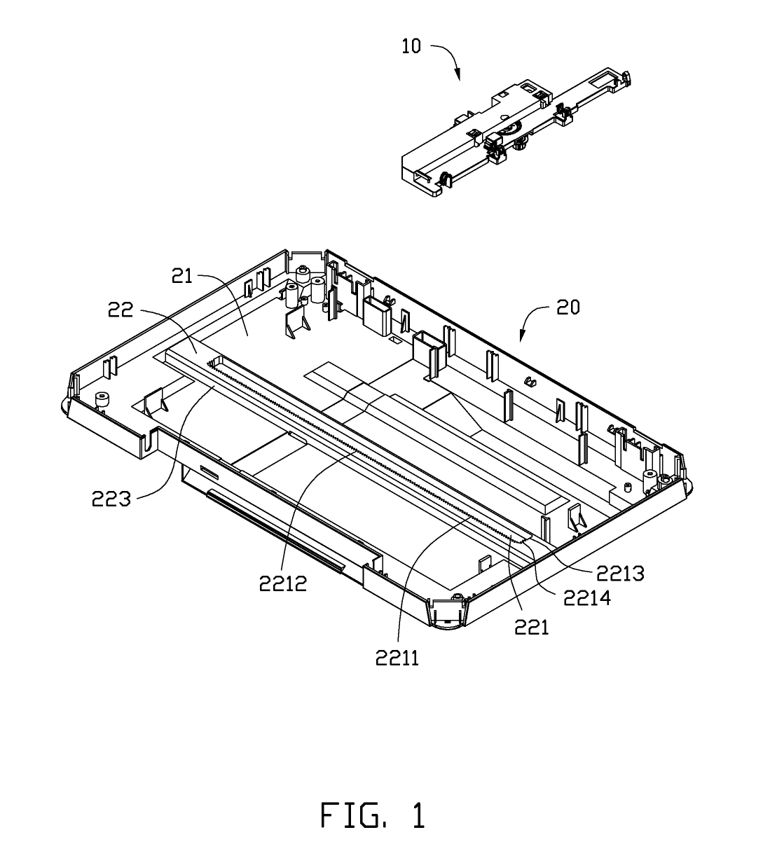

Referring to FIG. 1, one embodiment of a scanner is shown. The scanner includes a scanning module 10 and a base 20 for mounting the scanning module 10.

The scanning module 10 includes a loading panel 11, a driving module 12, an assistant gear 13, two chain wheels 14 mounted on the loading panel 11, and a sensing module (not shown) mounted on the loading panel 11. In one embodiment, the sensing module is a contact image sensor (CIS) module.

The driving module 12 includes a motor 121 and a worm gear assembly 122. The motor 121 includes a worm 1211. The worm gear assembly 122 includes a worm gear 1221 for engaging the worm 1211 and a slave gear 1222 having the same axis with the worm gear 1221. The assistant gear 13 and the slave gear 1222 are the same size. The worm 1211 can be rotated, when the motor 121 is spinning, to drive the worm gear 1221. The slave gear 1222 is driven to be rotated by the worm gear 1221

The base 20 includes a bottom panel 21 and a sliding portion 22 extending from the bottom panel 21. The sliding portion 22 defines a rectangular sliding slot 221. The sliding portion 22 includes an outer side surface 223. The sliding slot 221 defines a longer side surface 2211 that is substantially perpendicular to the loading panel 11, and two shorter side surfaces 2213 perpendicularly extending from the longer side surface 2211. A plurality of continuous first teeth slots 2212 is defined along the longer side surface 2211 corresponding to the slave gear 1222 and the assistant gear 13. A plurality of continuous second teeth slots 2214 is defined in each of the shorter side surface 2213.

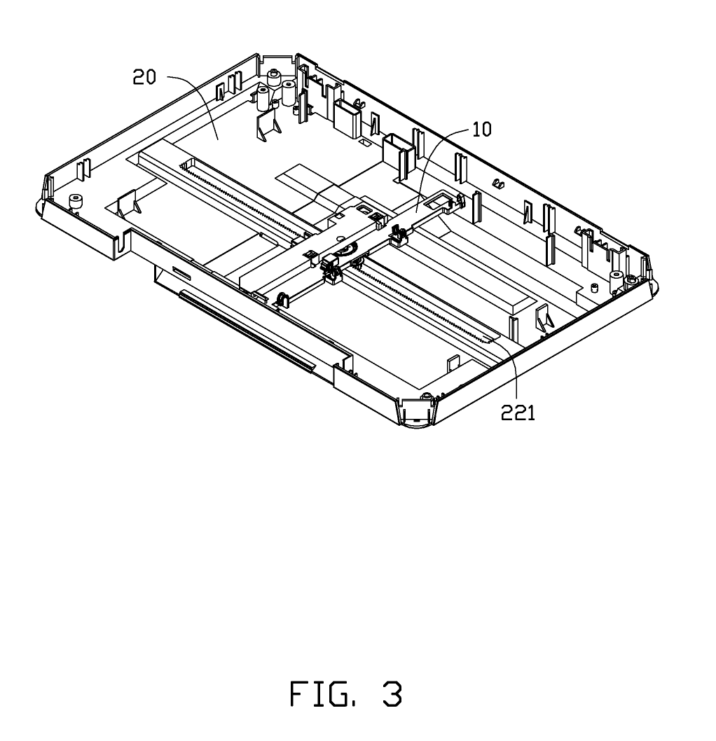

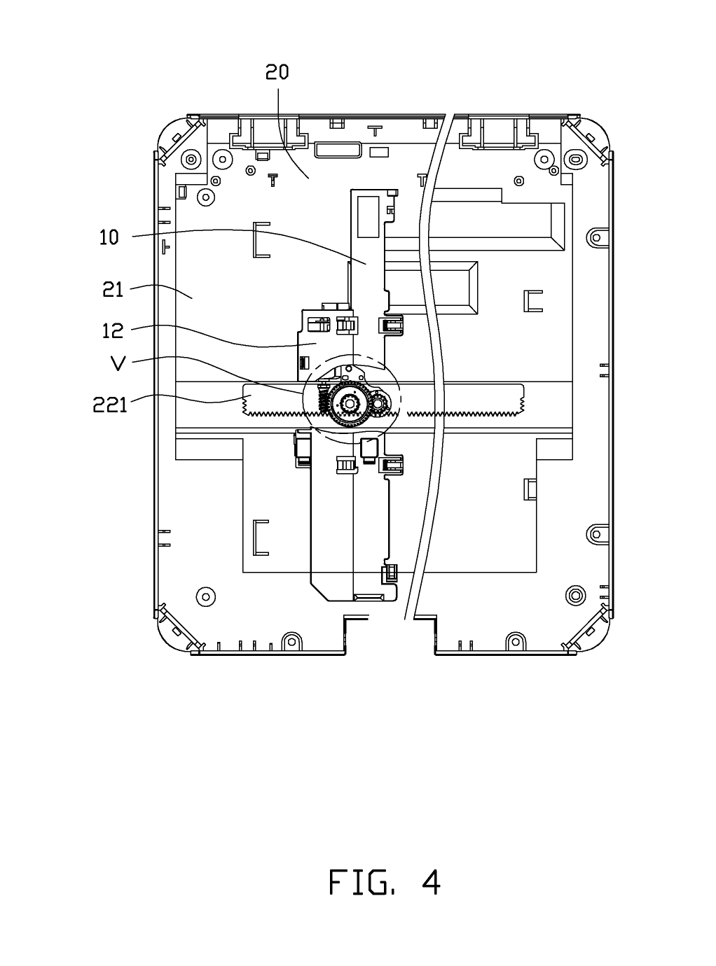

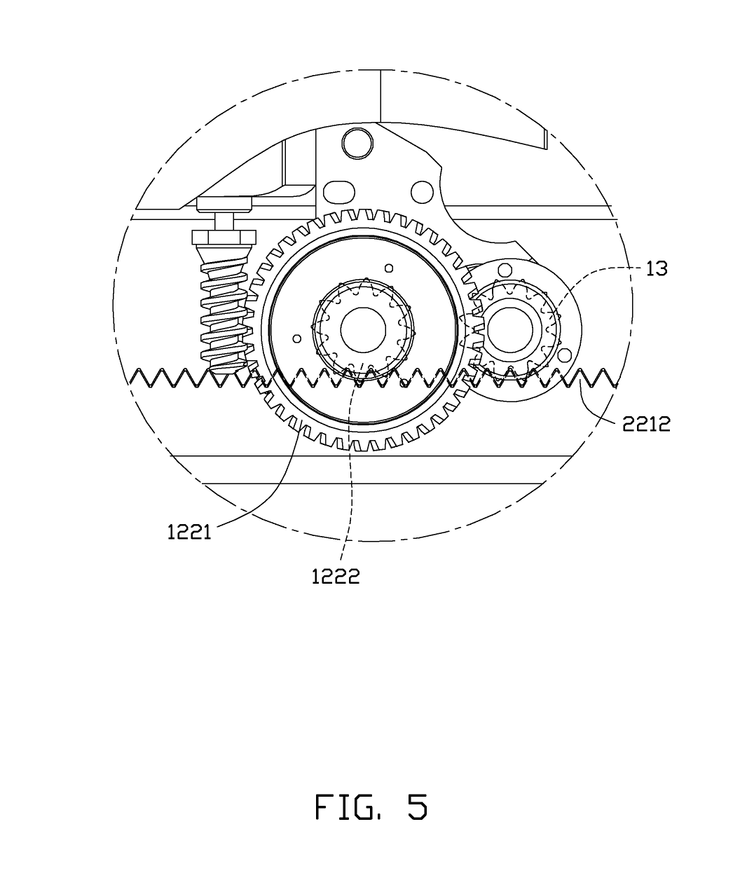

Referring to FIGS. 3 to 5, in assembly, the slave gear 1222 and the assistant gear 13 of the scanning module 10 are placed in the sliding slot 221 of the base 20 and engage with the first teeth slots 2212. At this time, the two chain wheels 14 are adjacent to the outer side surface 223 of the sliding portion 22.

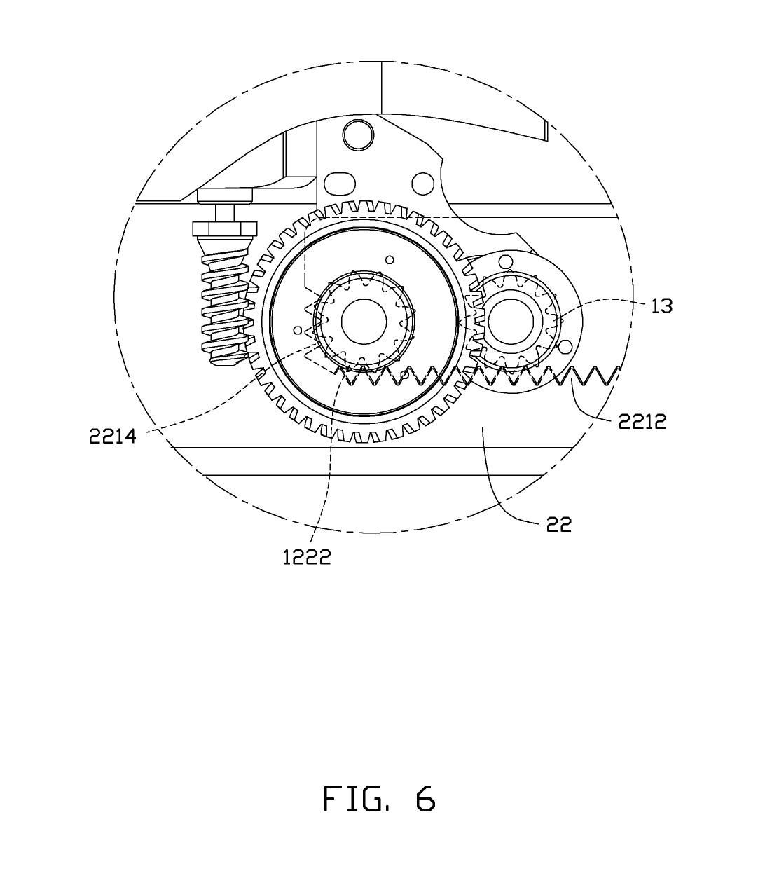

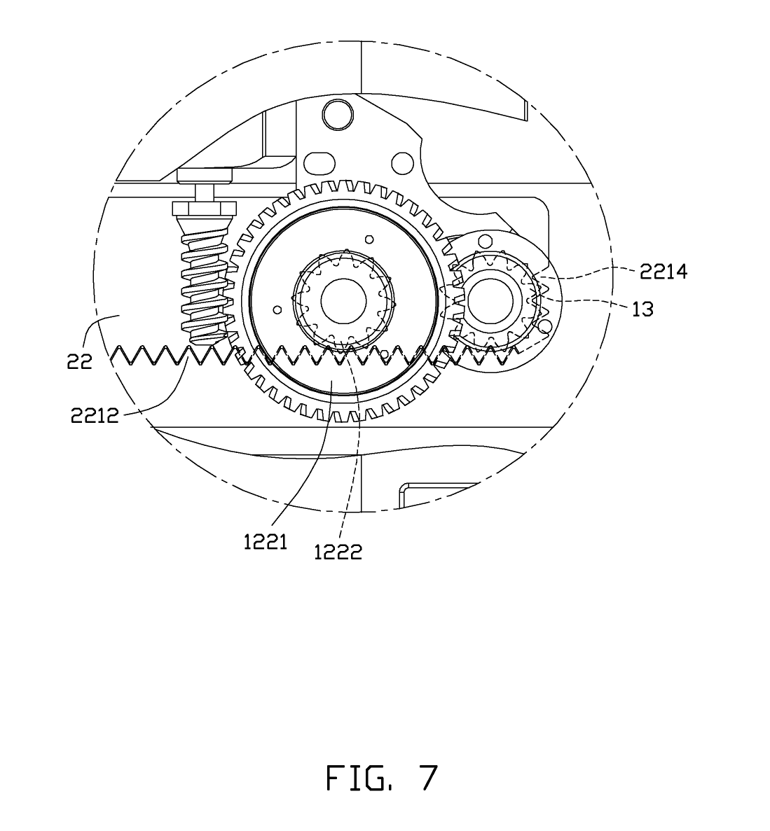

The worm 1211 rotates the worm gear 1221 when the motor 121 of the driving module 12 is spinning. The slave gear 1222 is driven by the worm gear 1221 to be rotated and thus to move along the longer side surface 2211 of the sliding slot 221. The assistant gear 13 is rotated and moves with the slave gear 1222. At this time, the two chain wheels 14 move along the outer side surface 223. The scanning module 10 moves towards one of the two shorter side surfaces 2213 according to the rotating direction of the worm 1211 (which may be clockwise or counter-clockwise). When the scanning module 10 has moved to one of the two shorter side surfaces 2213, the slave gear 1222 engages with the second teeth slots 2214 of the shorter side surface 2213 (shown in FIG. 6) to prevent the slave gear 1222 from rotating further, thereby stopping the motor 121 from rotating. When the scanning module 10 has moved to the other one of the two shorter side surfaces 2213, the assistant gear 13 engages with the second teeth slots 2214 of the other one (shown in FIG. 7) to prevent the slave gear 1222 from rotating further, again thereby stopping the motor 121 from rotating.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A scanner comprising:
a base, the base comprising a bottom panel and a sliding portion extending from the bottom panel; a sliding slot defined in the sliding portion; the sliding slot defining a longer side surface and a first shorter side surface extending from the longer side surface, a plurality of first teeth slots defined in the longer side surface and a plurality of second teeth slots defined in the first shorter side surface; and
a scanning module, the scanning module comprising a loading panel and a driving module, the driving module comprising a worm gear assembly engaging the plurality of first teeth slots and capable of moving along the longer side surface; the worm gear assembly adapted to engage the plurality of second teeth slots to prevent the scanning module from moving when the scanning module moves to the first shorter side surface along the longer side surface.

2. The scanner of claim 1, wherein the scanning module further comprises an assistant gear; the sliding slot further defines a second shorter side surface extending from the longer side surface, a plurality of third teeth slots defined in the second shorter side surface; and the assistant gear engages the plurality of third teeth slots to prevent the scanning module from moving when the scanning module moves to the second shorter side surface along the longer side surface.

3. The scanner of claim 2, wherein the second shorter side surface is substantially perpendicular to the longer side surface.

4. The scanner of claim 1, wherein the first shorter side surface is substantially perpendicular to the longer side surface.

5. The scanner of claim 4, wherein the scanning module further comprises a chain wheel mounted on the loading panel; the sliding portion includes an outer side surface; and the chain wheel is rotated to move along the outer side surface when the scanning module moves.

6. The scanner of claim 1, wherein the worm gear assembly comprises a worm gear and a slave gear having the same axis with the worm gear; the driving module further comprises a motor; and the worm gear engages the motor and the slave gear engages the plurality of first teeth slots.

7. The scanner of claim 6, wherein the motor comprises a worm engaging the worm gear.

8. A scanner comprising:
a base, the base comprising a bottom panel and a sliding portion extending from the bottom panel; a sliding slot defined in the sliding portion; the sliding slot defining a longer side surface and a first shorter side surface extending from the longer side surface, the longer side surface substantially perpendicular to the first shorter side surface; a plurality of first teeth slots defined in the longer side surface and a plurality of second teeth slots defined in the first shorter side surface; and
a scanning module, the scanning module comprising a loading panel substantially perpendicular to the longer side surface and a driving module, the driving module comprising a worm gear assembly engaging the plurality of first teeth slots and capable of moving along the longer side surface in a first direction substantially perpendicular to the loading panel; the worm gear assembly adapted to engage the plurality of second teeth slots to prevent the scanning module from moving in the first direction when the scanning module moves to the first shorter side surface along the longer side surface.

9. The scanner of claim 8, wherein the scanning module further comprises an assistant gear; the sliding slot further defines a second shorter side surface extending from the longer side surface, the longer side surface substantially perpendicular to the second shorter side surface; a plurality of third teeth slots defined in the second shorter side surface; and the assistant gear engages the plurality of third teeth slots to prevent the scanning module from moving a second direction opposite to the first direction when the scanning module moves to the second shorter side surface along the longer side surface.

10. The scanner of claim 8, wherein the scanning module further comprises a chain wheel mounted on the loading panel; the sliding portion includes an outer side surface; and the chain wheel is rotated to move along the outer side surface when the scanning module moves.

11. The scanner of claim 8, wherein the worm gear assembly comprises a worm gear and a slave gear having the same axis with the worm gear; the driving module further comprises a motor; and the worm gear engages the motor and the slave gear engages the plurality of first teeth slots.

12. The scanner of claim 11, wherein the motor comprises a worm engaging the worm gear.
